(19) United States
(12) Patent Application Publication
(10) Pub. No.: US 2005/0226511 A1
(43) Pub. Date: Oct. 13, 2005

(54) Apparatus and method for organizing and presenting content

(76) Inventor: Gordon K. Short, Palo Alto, CA (US)

Correspondence Address: GLENN PATENT GROUP, 3475 EDISON WAY, SUITE L, MENLO PARK, CA, 94025, US

(21) Appl. No.: 11/045,640

(22) Filed: Jan. 27, 2005

Related U.S. Application Data
(63) Continuation-in-part of application No. 10/649,008, filed on Aug. 26, 2003.
(60) Provisional application No. 60/406,010, filed on Aug. 26, 2002.
(60) Provisional application No. 60/540,398, filed on Jan. 29, 2004.

(51) Int. Cl. G06K 9/62

(52) U.S. Cl. 382/225

(57) ABSTRACT

An apparatus and method for content management allows a large volume of incoming content to be classified and retrieved in real time. Content items are automatically analyzed and a signature generated for each item. Content items are classified into topic clusters by comparing each item's signature with the signature of previously defined topics. The content items are clustered based on the similarity of their signatures to the topic signatures. Topics are defined through selection of exemplary content items. By means of a graphical user interface, an operator defines the topic by selecting the exemplary articles from a listing. The operator may further define the topic by specifying attributes such as source, currency, and type. A graphical topic map allows the user to discern the relatedness of the various topics.

### CROSS REFERENCE TO RELATED APPLICATIONS

This application claims benefit of U.S. provisional patent application Ser. No. 60/540,398, filed Jan. 29, 2004, and is a continuation-in-part of U.S. patent application Ser. No. 10/649,008, filed Aug. 26, 2003, which claims benefit of U.S. provisional patent application Ser. No. 60/406,010, filed on 26 Aug. 2002, all of which are incorporated herein in their entirety by this reference thereto.

### BACKGROUND OF THE INVENTION

1. Field of the Invention

The invention relates to real time information processing in a computer environment. More particularly, the invention relates to real-time classification and presentation of content.

2. Description of Related Art

Organizations concerned with management and/or dissemination of media content, such as news organizations, must quickly deal with a large flow of content, rapidly retrieving and classifying it so that it can be packaged in ways that are meaningful and convenient to the target user. For example, a wire editor in a news organization is inundated with a flow of numerous articles in the stream of information provided by wire services, such as AP NEWSWIRE (ASSOCIATED PRESS, New York N.Y.). The wire editor is required to make sense of all these stories, perhaps up to ten thousand per day, and to offer a perspective to the managing editors and the editors of each of the sections of the publication, including an overview of the important stories of the day and, further, recommend an overview to each of the sections of the publication, such as sports, entertainment, and international.

Complicating this flow is the fact that there may be a number of different stories, each of which is on the same subject. For example, a catastrophic event, such as a school bus falling off of a bridge, might be the subject of an initial wire stating some simple facts. Then, an hour or so later, reporters may have developed more information, such that so an update to the original wire is sent. Perhaps an hour or so after that, the reporters may have interviewed a broader scope of persons and have analysis information. Again, another update to the story is sent. In parallel to this, there may be four or five or more competing news services issuing bulletins and updates about this one event. Yet, to the wire service, it is just a constant flow of disconnected stories among thousands of others sent out.

Another complication is that there may be many stories with different angles that relate only topically, for example, SARS, (Severe Acute Respiratory Distress Syndrome). At the height of the SARS scare there were numerous stories in the wire services about different aspects of the outbreaks. Stories about the disease itself, how it came to be, how scientists were decoding it, where outbreaks were occurring, how the World Health Organization was dealing with the crisis, how the specific hospitals and cities were dealing with it, the affect on international travel, and the affect on political stability and processes on China, to name only a few of the range of stories concerning SARS. This resulted in a large number of stories about SARS which might have appeared in different sections of the publication in a version that reflected the focus of the section in that publication. Further, different news organizations produced competing stories leading to much replication of information. Yet, the wire editor needs to sort out all these stories and put each in the context of its own section in the publication, as well as recommend a balance both overall and to the front page for the readership.

Another complication is that among the flow of stories are bulletins concerning special information of interest, such as weather bulletins, sports scores of games in progress, market updates, future markets, headline summaries, and more. Together, these may constitute thirty to fifty percent of the incoming story traffic, and must be dealt with accordingly and quickly within the priority of the publication.

C. Duke-Moran, S. Weiner, Searching media and text information and categorizing the same employing expert system apparatus and methods, U.S. Pat. No. 5,819,259 (Oct. 6, 1998) describe an expert system that employs a rule base and a knowledge base to perform media searching. The user specifies the rules base by selecting key words from a display. Additionally, the user may specify other parameters, such as article type, age level, and so on. While the system allows the user to identify media items in real time that conform to pre-selected criteria, the criteria are fundamentally limited to the occurrence of pre-selected keywords or phrases in the items.

It would be a great advantage to provide a system based on natural language processing that creates signatures for each item and compares the item's signature to a topic signature.

P. Lebling, A. Elterman, Newsroom user interface including multiple panel workspaces, U.S. Pat. No. 6,141,007 (Oct. 31, 2000) describe a newsroom user interface having multiple panels. One panel displays a queue of new stories from a data file. A second panel displays the text of a news story selected from the queue. Accordingly, what is described is a user interface that facilitates selecting and viewing retrieved content.

It would greatly advance the art to provide a user interface that allowed a user to define a topic rapidly and view and manipulate topic clusters to classify items of content rapidly.

K. Ohishi, T. Kii, K. Okuyama, N. Iwayana, Article posting apparatus, article relationship information managing apparatus, article posting system, and recording medium, U.S. Pat. No. 6,222,534 (Apr. 24, 2001) describe a system wherein users post icons representing articles on a display screen, so that a graphical representation of a message board is created. Each article is represented by an icon. To respond to or comment on a previously posted article, the user places the icon in the proximity of the icon for the original article, thus creating clusters of icons.

It would be advantageous to provide a user interface, wherein a user could quickly define and manipulate topics graphically and view topic clusters that illustrate the relatedness of the various topics and their associated content.

Thus, there exists a need in the art for a way to process and classify the separate items in a large content stream quickly. It would be a great advantage to process and classify the content items in real time. It would be a significant advance in the art to use such methods as NLP (natural language processing) and clustering to provide a simple way of defining a topic, and organizing the content items into viewable, manipulable topic clusters based on their similarity to each topic definition. It would also be desirable to provide an interactive topic interface for an operator to affect clustering dynamically, as the day's news develops.

### SUMMARY OF THE INVENTION

The invention is directed to an apparatus, methods and user interface for content management that satisfies these needs. The invention allows a large volume of incoming content to be classified and retrieved in real time.

In one embodiment, the invention provides a content management system that comprises one or more modules for automatically generating a signature for each of the items in a content steam, based on real-time analysis of content of said content items; one or more modules for comparing content item signatures with topic signatures; one or more modules for clustering the content items according to topic based on similarity of each content item's signature to one or more topic signatures; and a user interface for viewing and manipulating clustered content items by an operator using a graphical metaphor

In another embodiment, the invention provides a method for categorizing and presenting content that comprises the steps of automatically generating a signature for each of the items in a content stream, based on real-time analysis of content of the content items; comparing content item signatures with topic signatures; clustering the content items according to topic based on similarity of each content item's signature to at least one topic signature; and viewing and manipulating the clustered content items by an operator using a GUI. Each content item is automatically analyzed and a signature generated for the item. Content items are classified into topic clusters by comparing each item's signature with the signature of previously defined topics. The content items are clustered based on the similarity of their signatures to the topic signatures.

In another embodiment, the invention provides a graphical user interface for clustering of content items according to topic that comprises at least topic definition, topic list and topic map views. Topics are defined through selection of exemplary content items. By means of the graphical user interface, an operator defines the topic by selecting the exemplary articles from a listing. The operator may further define the topic by specifying attributes, such as source, currency, and type. The user interface generates a topic map that allows the user to discern the relatedness of the various topics. Topics with associated content items can also be displayed in a list view. Using the list view, the operator can modify the selection of items in the topic cluster.

The invention enables the operator to search out best fit stories using a story or combination of stories as search terms rather than keywords. The invention presents the operator with a visual display of categories with a one-click drill down to get the details of each category designed by the operator. While an embodiment of the invention is described that relates to real-time analysis and classification of stories received from a wire service, the principles of the invention find broad application in a number of settings. For example, the invention is applicable to libraries, online services, knowledge management applications, commercially produced content databases, newsgroups, and message boards.

### BRIEF DESCRIPTION OF THE DRAWINGS

FIG. 1 is a block diagram showing a system for content management according to the invention;

FIG. 2 is a flowchart showing a method for classifying and presenting content according to the invention;

FIG. 3 is a flow diagram showing a process for defining a topic according to the invention;

FIG. 4 shows a view for defining a topic from a user interface for clustering content items by topic according to the invention;

FIG. 5 shows a topic list view from a user interface for clustering content items by topic according to the invention; and

FIG. 6 shows a topic map from a user interface for clustering content items by topic according to the invention.

### DETAILED DESCRIPTION

The invention is directed to a system and method for content management wherein a user interface for story analysis allows a topic to be defined and individual content items organized into topic clusters by comparing signatures of the content items with topic signatures.

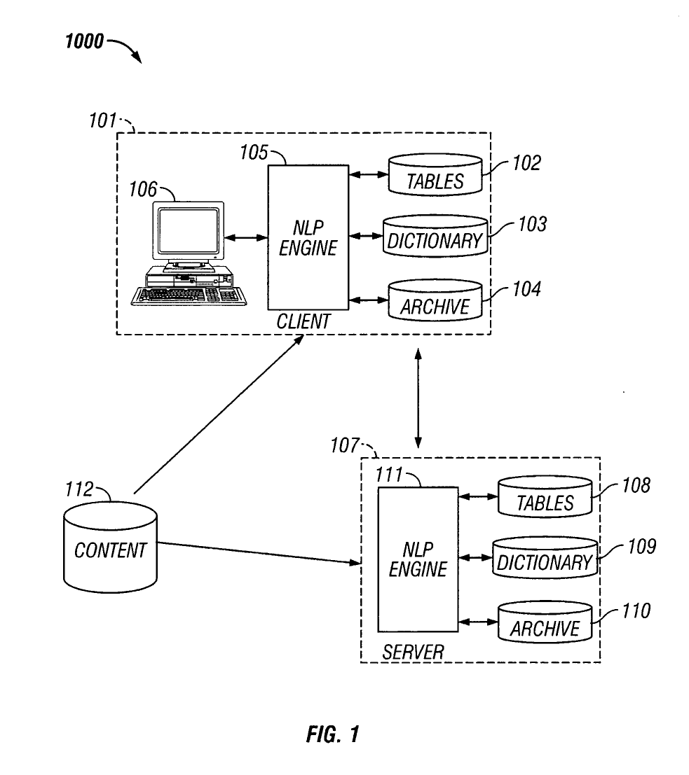

In a first embodiment, as shown in FIG. 1, the invention provides a system and method for organizing and presenting content. The invented system comprises at least one client 101 that receives a stream of content from a content source 110. The client 101 comprises an NLP engine 105, an archive 104, a dictionary of terms 103, and a lexicon comprising a plurality of lexical tables 102. As content items are received from the source 110, they are analyzed by the NLP engine 105 based on the dictionary and tables, 103 and 102 respectively, and deposited in the archive 104. Additionally, the client includes an interface component 106 whereby an operator of the client 101 uses and interacts with the system 100. The lexical tables are constructed from the semantic and statistical data generated during the NLP analysis of the various content items. The invention uses a signature algorithm, described in detail in the parent application Ser. No. 10/649,008. Each item has a unique signature that can be used to distinguish it from any other item. A signature is a vector of words and their weighting within the document. The weighting is determined by the importance of the word in collocations and within the document. The items and the accompanying signatures are deposited in the archive 104.

As shown in FIG. 1, the invention may also comprise a central server 107 in communication with the client 101. Residing on the server 107 also may be an engine 111, an archive 110, a dictionary 109, and a lexicon comprising a plurality of lexical tables 108. A related application, G. Short, Dynamic Lexicon, U.S. patent application Ser. No. 10/938,336 (Sep. 9, 2004), herein incorporated in its entirety by this reference thereto, describes a system and method that allows updating of the local dictionary 103 in real time by downloading an extension to the tables from the central server 107 whenever a new term is encountered. At predetermined intervals, the client downloads updates to the dictionary that include newly-computed lexical values for each term in the dictionary.

The embodiment of FIG. 1 is provided for the purpose of illustration only and is not intended to limit the invention. In actual practice, the invention may include a plurality of clients, each in communication with the server. In fact, a major advantage of the solution provided by the invention is its scalability to systems involving large numbers of clients.

As the content management system is running, the client 101 encounters new words that are not in the dictionary and lexicon of the client. For example, the medical term SARS (Severe Acute Respiratory Syndrome), before its first appearance in the media, was theretofore unknown. Therefore, the importance and associations of the word would have been unknown to an NLP system encountering the term for the first time. Yet, within a very short period of time after the appearance of this word in the news, perhaps a minute or less, content management systems needed to recognize this term and associate it appropriately within the archive of documents in the system.

The invention relies on a group of related algorithms to provide its unique functionality. The algorithms include:
Signature
   The invention uses a signature algorithm to calculate signatures for each content item. A signature is a vector of words and their weighting within the document. The weighting is determined by the importance of each word in its collocations and within the document.
   Each item has a unique signature that can be used to cross-reference against other items. The invention calculates signatures for content items as previously listed.
Inverted Index
   An inverted index algorithm creates an index for each word from the signature vector for a text document and then saves the index, word, text document, and weight of the word into a database that can be used later to find text documents that have similar signatures.
Clustering, Classification, and Categorization
   The invention uses the signature of the text document to do:
      mathematical clustering;
      matching text documents to predefined categories; and
      cross-referencing the document to other similar documents using the signature for each document.
Clustering
   The clustering algorithm uses the signatures and weights of the words to create sets of documents that have similar signatures.
Categorization
   The categorization algorithm calculates signatures for predefined categories. The categorization algorithm then matches signatures for other text documents to the signatures of the pre-defined categories and determines which categories to assign to the content item.
   As more items are processed, the signatures for the predefined categories are improved to improve the accuracy of the categorization.
Cross-Referencing/What's Related
   The invention uses a formula to calculate the similarity score between two or more documents. Documents that have a similarity score near the threshold limit are defined as similar documents.

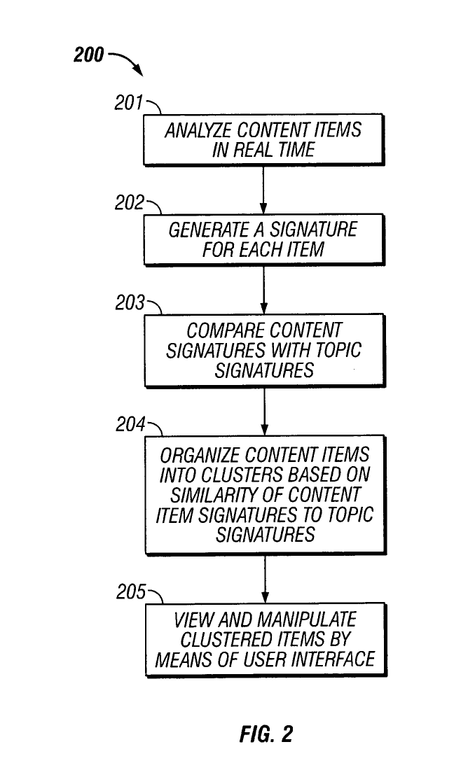

In a second aspect, as shown in the flow chart of FIG. 2, the invention provides a method 200 for categorizing and presenting content that comprises steps of:
analyzing content items in real time 201;
generating a signature for each item 202;
comparing content signatures with topic signatures 203;
organizing content items into clusters based on similarity of content item signatures to topic signatures 204; and
viewing and manipulating clustered items by means of user interface 205.

An NLP engine analyzes incoming content items, generating a signature for each item and depositing the item in an archive. While the invention is described herein with respect to wire stories or news stories, the invention also finds application in any setting involving classification, management, and retrieval of textual and multimedia content; for example, libraries, information vendors, such as DIALOG (THOMSON CORP., CARY N.C.), database producers, and knowledge management organizations. Moreover, the invention finds application in classifying and managing content on message boards, newsgroups, and other such settings.

The relatedness of each item in the archive to predetermined topics is determined by comparing the item's signature to the signature of each of the topics. The items of the archive are then organized into topic clusters based on their similarity to the defined topics.

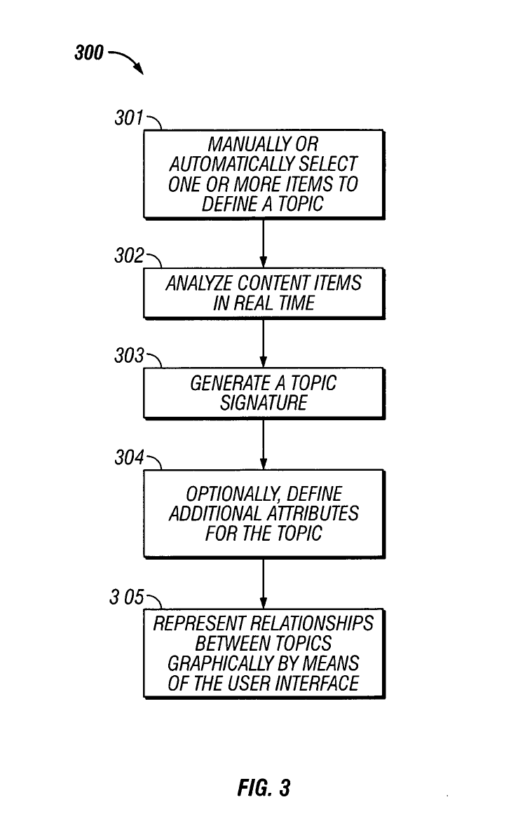

FIG. 3 is a flowchart showing a process 300 for defining a topic that comprises steps of:
manually or automatically selecting one or more items to define a topic 301;
analyzing content items in real time 302;
generating a topic signature 303;
optionally, defining additional attributes for the topic 304; and
representing relationships between topics graphically by means of the user interface 305.

Topics are generated by selecting one or more content items. As described supra, each item has been previously analyzed and a signature therefore generated and saved. A topic signature is generated based on the aggregate signatures of the items selected to define the topic. The topic items may be manually selected by an operator, such as an editor. In the alternative, topic items may be automatically selected.

Additional attributes may be used to define a topic. For example, one or more sources can be specified. Other attributes include currency, priority, and media type. Topics can be defined to be mutually exclusive or to allow clustering of content items with more than one topic.

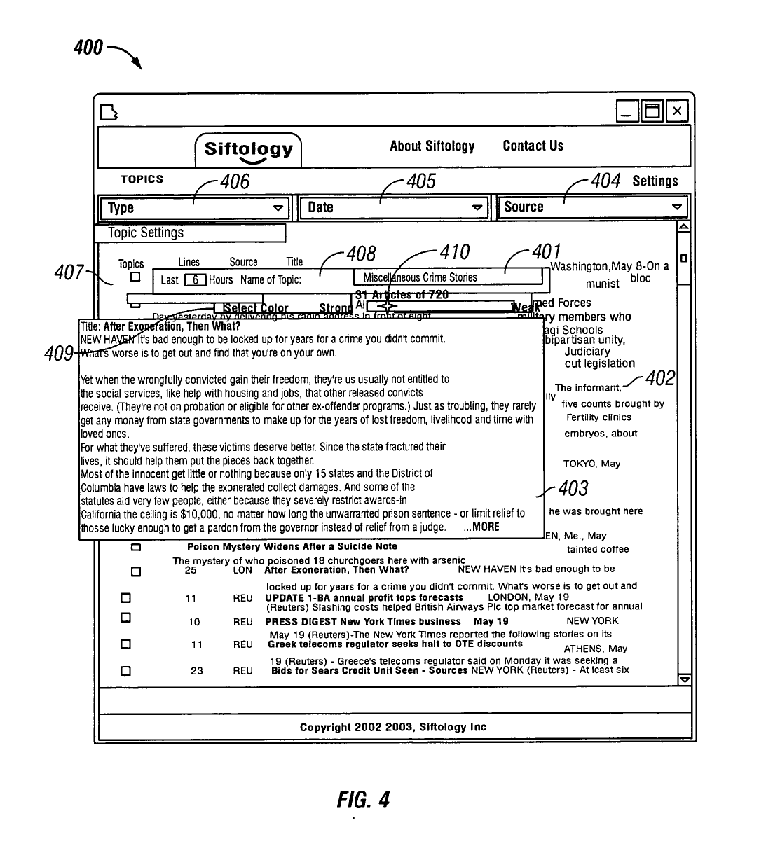

In a further embodiment, the invention provides a graphical user interface (GUI) for clustering of content items according to topic that allows an operator to perform the operations described above easily by manipulating interface elements according to a graphical metaphor. In one embodiment of the invention, the user interface comprises at least a view for defining a topic, a topic list view, and a topic map as shown in FIGS. 4, 5, and 6, respectively. Within the context of the invention, a view is understood to refer to a workspace provided with task-specific interface elements to be activated and manipulated by an operator. In an exemplary embodiment of the invention, the workspace is a windowed workspace as provided in conventional graphical, event-driven operating systems, such as WINDOWS (MICROSOFT CORP., Redmond Wash.)

FIG. 4 shows a view 400 for defining a topic. A list 402 of content items in the archive is displayed in a window. To define a topic, the operator selects one or more of the items from the list, for example, by selecting the item with a pointing tool, such as a mouse. When the item is selected, the item is displayed in a child window 403. Using a selection of interface elements and controls in parent and child windows, the operator can further define the topic. The elements can comprise any of the following:
a text box 401 for entering a title;
a pull down menu 404 from which a source may be selected;
a pull down menu 405 from which a date may be selected;
a pull down menu 406 from which a media type may be selected;
a text box 407 for entering an author;
a text box 408 for specifying currency;
a selection box 409 for specifying a color to represent the topic; and
a slider bar for specifying for specifying relatedness for inclusion in the topic.

All views allow the operator to drill down to view the details of each topic designed by the operator by performing an action such as right-clicking on the title of the item.

While the GUI has been described herein as having particular user interface elements and controls for performance of various functions, other interface elements and controls for performing the same or equivalent functions are entirely consistent with the spirit and scope of the invention. For example, a text box could be substituted for a pull down menu, or another means of drilling down could be substituted for right-clicking.

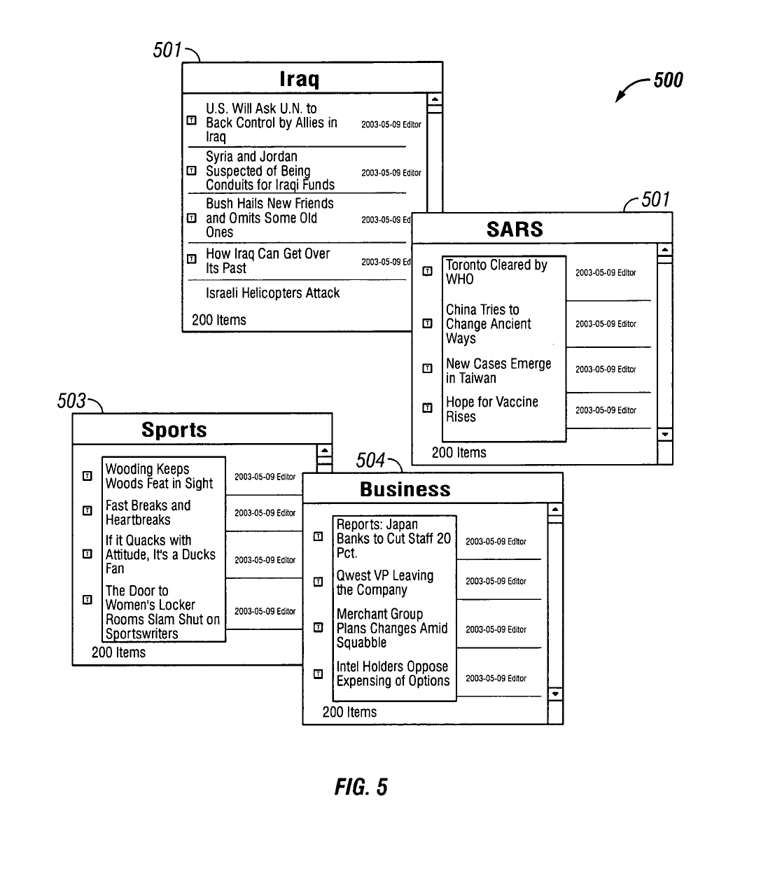

FIG. 5 shows a topic list view 500. FIG. 5 shows a plurality of list boxes, each box representing a topic. Each box displays a title bar 501-504, bearing the title of the topic and rendered in the color selected when defining the topic. Key metadata for each of the items associated with the topic is displayed in list form. Scrollbars are provided so that users can quickly scroll through the list. The ordering of the list items is also configurable, allowing stories to be ordered at least by relevance or by length. One skilled in the art will readily appreciate that other ordering schemes are possible, such as by source or alphabetically by title. The spatial arrangement of the list boxes within the workspace graphically depicts the amount of overlap and the degree of relatedness between topics.

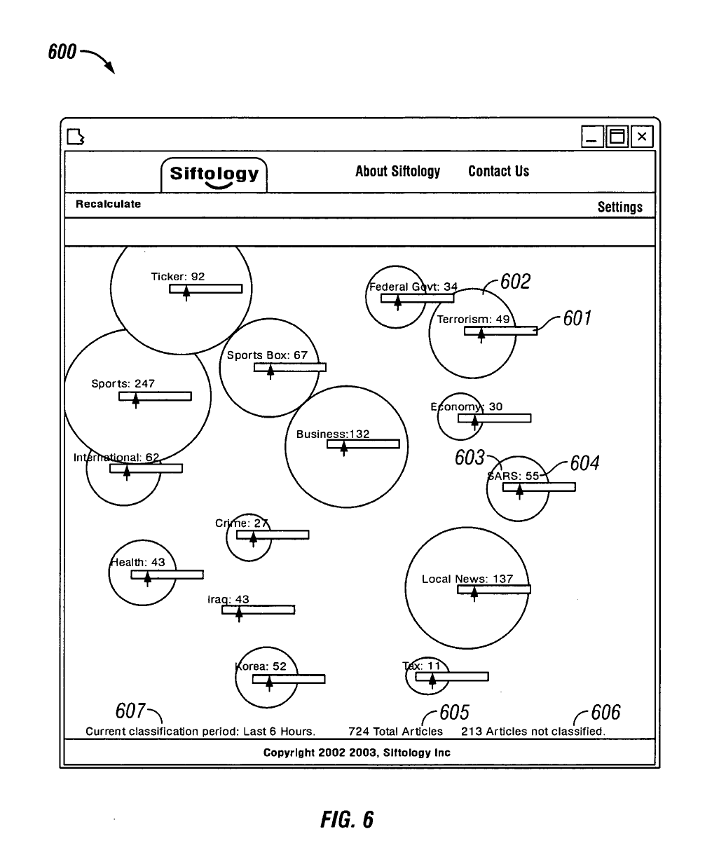

FIG. 6 shows a topic view 600 from the user interface of FIG. 4. The topic view allows the operator to view all topics at a glance, each topic being represented by a circle 602. The color of the circle is that selected when the topic was defined. The title 603 of each topic is given along with the number of items 604 grouped with that topic. The size of the circle also corresponds to the number of items grouped within the topic. As with FIG. 5, the spatial arrangement and the overlap between the circles are indicative of the overlap and the relatedness between topics. The overlap and relatedness are configurable by the operator, either by using the topic definition interface as shown in FIG. 4, or by altering the spatial arrangement of the topic circles in the topic map of FIG. 5. For example, the overlap between the ‘sports’ and the ‘international’ topics can be eliminated by dragging the two circles farther apart. Dragging the circles apart has the effect of changing the strength of the respective grouping. The strength of the topic grouping can also be edited using the slider bar 601 provided for each grouping. Each topic grouping can be edited by double-clicking the corresponding circle. Each circle also displays the title of the topic. The bottom bar shows the total number of articles 605 in the archive for the period specified 607, and the number of articles not yet classified 606. Double-clicking the bottom bar allows the operator to view the list of articles not yet classified, and to define new topics.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method for categorizing and presenting content, comprising steps of:
automatically generating a signature for each of a plurality of content items based on real-time analysis of content of said content items;
comparing content item signatures with topic signatures;
clustering said content items according to topic based on similarity of each content item's signature to at least one topic signature; and
viewing and manipulating said clustered content items by an operator using a GUI (graphical user interface).

2. The method of claim 1, wherein said content items comprise an archive.

3. The method of claim 1, wherein said archive comprises a plurality of news stories.

4. The method of claim 2, further comprising the step of:
selecting at least one content item from which a topic signature is generated.

5. The method of claim 4, further comprising the step of:
analyzing content of said selected at least one content item with an NLP (natural language processing) engine to generate said topic signature.

6. The method of claim 4, wherein said content items are selected by said editor.

7. The method of claim 4, wherein said content items are automatically selected.

8. The method of claim 1, further comprising the step of:
performing said real-time analysis with an NLP engine.

9. The method of claim 1, wherein a topic is defined according to one or more additional attributes.

10. The method of claim 9, wherein said additional attributes comprise any of:
source;
priority; and
age.

11. The method of claim 1, further comprising the steps of:
defining topics so that a content item can be clustered with more than one topic.

12. The method of claim 1, wherein said operator comprises an editor.

13. The method of claim 13, wherein said step of viewing and manipulating said clusters comprises any of:
segregating items into narrower topics;
creating a new topic; and
adjusting a topic.

14. The method of claim 1, wherein a cluster comprises additional information to assist in presentation of the topics.

15. The method of claim 14, further comprising the step of:
overriding a relationship between topics by said operator.

16. The method of claim 14, wherein relative positions of topic clusters on a graphical representation indicate an interrelationship of two or more topics.

17. The method of claim 14, wherein color shades demonstrate relationships between topics.

18. A content management system, comprising:
at least one module for automatically generating a signature for each of a plurality of content items based on real-time analysis of content of said content items;
at least one module for comparing content item signatures with topic signatures;
at least one module for clustering said content items according to topic based on similarity of each content item's signature to at least one topic signature; and
a user interface for viewing and manipulating said clustered content items by an operator.

19. The system of claim 18, wherein said user interface is embodied on a client.

20. The system of claim 18, wherein said modules are embodied on a client.

21. The system of claim 18, wherein said modules are embodied on a server.

22. The system of claim 18, wherein said content items comprise an archive.

23. The system of claim 22, wherein said archive comprises a plurality of news stories.

24. The system of claim 22, said user interface comprising means for selecting at least one content item from which a topic signature is generated.

25. The system of claim 24, further comprising:
means for analyzing content of said selected at least one content item with an NLP (natural language processing) engine to generate said topic signature.

26. The system of claim 24, wherein said content items are selected by said editor.

27. The system of claim 24, wherein said content items are automatically selected.

28. The system of claim 24, further comprising:
means for performing said real-time analysis with a NLP engine.

29. The system of claim 24, wherein a topic is defined according to one or more additional attributes.

30. The system of claim 29, wherein said additional attributes comprise any of:
source;
priority; and
age.

31. The system of claim 24, further comprise:
means for defining topics to cluster a content item with more than one topic.

32. The system of claim 24, wherein said operator comprises an editor.

33. The system of claim 32, wherein said user interface comprising elements for any of:
segregating items into narrower topics;
creating a new topic; and
adjusting a topic.

34. The system of claim 24, wherein a cluster comprises additional information to assist in presentation of the topics.

35. The system of claim 34, said user interface comprising at least one element for:
overriding a relationship between topics by said operator.

36. The system of claim 35, wherein position of a topic cluster on a graphical representation indicates an interrelationship of two or more topics.

37. The system of claim 35, wherein color shades demonstrate relationships between topics.

38. A graphical user interface for clustering of content items according to topic, comprising:
a topic definition view;
a topic list view; and
a topic map view;
wherein an operator defines at least one topic and clusters said content items according to topic.

39. The user interface of claim 38, wherein said topic definition view comprising:
means for selecting at least one content item from which a topic signature is generated.

40. The user interface of claim 39, wherein said at least one content item is either manually or automatically selected.

41. The user interface of claim 39, wherein said topic definition view comprises means for defining said at least one topic according to at one or more additional attributes.

42. The user interface of claim 41, wherein said additional attributes comprise any of:
source;
priority; and
age.

43. The user interface of claim 38, wherein topics are defined so that a content item can be clustered with more than one topic.

44. The user interface of claim 38, wherein said operator comprises an editor.

45. The user interface of claim 38, wherein said topic map view comprises elements for any of:
segregating items into narrower topics;
creating a new topic; and
adjusting a topic.

46. The user interface of claim 38, wherein said topic list view and said topic map views display additional information contained in a cluster to assist in presentation of the topics.

47. The user interface of claim 46, wherein position of topics relative to each other in a view represents an interrelationship of said topics.

48. The user interface of claim 47, said user interface comprising at least one element for:
overriding a relationship between topics by said operator.

49. The user interface of claim 46, wherein position of a topic cluster in one or both of said list view and said topic map view indicates an interrelationship of two or more topics.

50. The user interface of claim 46, wherein color shades demonstrate relationships between topics.
